(19) United States
(12) Patent Application Publication
(10) Pub. No.: US 2013/0151126 A1
(43) Pub. Date: Jun. 13, 2013

(54) DEVICE AND METHOD FOR OPERATING A HAND-HELD WORKING APPARATUS

(71) Applicants: Michael Harrer, Pleinfeld (DE); Heiko Däschner, Leutenbach (DE); Robert Böker, Winnenden (DE)

(72) Inventors: Michael Harrer, Pleinfeld (DE); Heiko Däschner, Leutenbach (DE); Robert Böker, Winnenden (DE)

(73) Assignee: ANDREAS STIHL AG & CO. KG, Waiblingen (DE)

(21) Appl. No.: 13/693,447

(22) Filed: Dec. 4, 2012

(30) Foreign Application Priority Data
Dec. 10, 2011 (DE) 10 2011 120 812.0

(51) Int. Cl. F02D 45/00

(52) U.S. Cl. CPC F02D 45/00
USPC 701/110

(57) ABSTRACT

A hand-held working apparatus has an internal combustion engine having a crankshaft which is driven in rotation. The crankshaft drives at least one tool of the working apparatus via a centrifugal clutch. The working apparatus has a device for determining the speed of the internal combustion engine and a control device which controls the internal combustion engine. It is provided that the profile of the speed of the internal combustion engine is evaluated by the control device, and that the engagement speed of the centrifugal clutch is determined from the profile of the speed of the internal combustion engine. A method of operation is also provided.

### CROSS-REFERENCE TO RELATED PATENT APPLICATIONS

This application is based upon and claims the benefit of priority from prior German Patent Application No. DE 10 2011 120 812.0, filed Dec. 10, 2011, the entire contents of which are incorporated herein by reference in their entirety.

### BACKGROUND

This application relates to device and method for operating a hand-held working apparatus with a control device, an internal combustion engine, a crankshaft, a tool, a centrifugal clutch, and a device for determining the speed of the internal combustion engine, wherein the control device evaluates the profile of the speed of an internal combustion engine and determines the engagement speed of a centrifugal clutch from the profile of the speed of the internal combustion engine and a method for operating a hand-held apparatus.

DE 10 2004 051 259 A1 discloses an internal combustion engine which drives a tool of a hand-held working apparatus via a centrifugal clutch. In order to avoid excessive heating of the centrifugal clutch during engagement, it is provided to monitor how long the speed remains in a speed range from the beginning of the engagement process to the end of the engagement process and, if the dwell time is too long, to act in a controlling manner therein. The upper and lower speeds of the speed range are permanently stored in the control circuit.

The engagement speed of a clutch is usually determined in hand-held working apparatuses during production or servicing of the apparatus, in that an operator accelerates the internal combustion engine into the range of the engagement speed by partial, targeted opening of the throttle of the internal combustion engine. Once the engagement speed has been set in this way, it can be changed, for example, by operating errors on the part of the operator, which cause excessive wear. This change in the engagement speed is not taken into account in control devices, into which the engagement speed is permanently programmed during production or maintenance, or in machines without an electric control device.

### SUMMARY OF PREFERRED EMBODIMENTS

It is one object to provide a device and method for operating a hand-held working apparatus, with which the actual state of the centrifugal clutch can be taken into consideration for the operation of the internal combustion engine.

This and other objects may be achieved by a method for operating a hand-held working apparatus comprising a control device, an internal combustion engine, a crankshaft, a tool, a centrifugal clutch, and a device for determining the speed of the internal combustion engine, wherein the control device evaluates the profile of the speed of an internal combustion engine and determines the engagement speed of a centrifugal clutch from the profile of the speed of the internal combustion engine.

In one embodiment, the control device evaluates the profile of the speed of the internal combustion engine, in particular the speed of the crankshaft, and determines the engagement speed. The control device may control the internal combustion engine by using the actual engagement speed. The engagement speed does not have to be permanently programmed into the control device as in known working apparatuses. As a result, a change in engagement speed, as occurs, for example, on account of wear due to operating errors on the part of the operator, can be determined and taken into consideration.

In another embodiment, the control device evaluates the characteristic kink in the speed curve of the control device which occurs during acceleration due to the engagement of the centrifugal clutch. In this embodiment, the control device determines a first speed from the speed profile, wherein the first speed is the speed at which the change in speed per time unit drops below a first limit value of the change in speed per time unit. The first limit value is stored in the control device. The first speed accordingly characterizes the speed at which the centrifugal clutch begins to engage, and, as a result, the speed rises less strongly or even drops slightly. In this embodiment, the control device determines a second speed from the speed profile, at which the change in speed per time unit rises above a second limit value of the change in speed per time unit. The second limit value is stored in the control device. The second speed accordingly characterizes the speed at which the centrifugal clutch has fully engaged, and the speed of the crankshaft thus rises strongly again. Advantageously, the average between the first and the second speed is determined as the engagement speed.

In yet another embodiment, the control device determines the engagement speed each time that the speed of the internal combustion engine rises more strongly from the idling mode over a given time period than a third limit value of the change in speed per time unit. The third limit value is stored in the control device. The third limit value characterizes the acceleration from the idling mode. The speed of the internal combustion engine fluctuates even in the idling mode. However, the time periods in which the speed rises are comparatively short. As soon as the operator actuates the throttle lever to accelerate the engine, the speed rises comparatively strongly over a relatively long time period. The given time period is longer than the time period for which a rise in speed in the idling mode usually lasts. In one example, the time period can be determined experimentally and may be stored in the control device.

In still another embodiment, the control device determines whether the operator would like to accelerate the engine by determining the rise in the change in speed from the idling mode. An acceleration wish on the part of the operator may also be determined in some other way than by evaluating the speed profile, for example by way of a sensor arranged on the throttle valve or throttle lever. It is also possible to provide a separate operating element that is actuated by the operator for the purpose of acceleration. It may also be provided for the internal combustion engine to start automatically following actuation of an operating element such as a start button or a switch and for an acceleration process to occur automatically after the starting process, without the operator having to actuate further operating elements.

In another embodiment, the control device controls the amount of fuel supplied to the internal combustion engine. Advantageously, the internal combustion engine may also have a device for supplying fuel as is known in the art. Advantageously, the internal combustion engine may have an ignition device, wherein the control device controls the ignition time. In internal combustion engines in which the control device controls the supplied amount of fuel or the ignition time, the control device may control the amount of fuel or the ignition time automatically when the control device detects acceleration by the operator as provided for previously. As a result, good and powerful acceleration may be achieved.

In some circumstances where an acceleration process proceeds automatically in a working apparatus following the detection of an acceleration wish on the part of the operator, it may no longer be possible for the engagement speed to be approached by partial actuation of the throttle lever by the operator. Therefore, in these working apparatuses, the engagement speed of the centrifugal clutch may not be determined manually by the operator. For such working apparatuses, it is advantageous for the control device to determine the engagement speed automatically from the resulting speed profile. As a result, shutting down the control device during acceleration in order to determine the engagement speed may be omitted. Therefore, in yet another embodiment, the control device controls the supplied amount of fuel and the ignition time such that the internal combustion engine accelerates from the idling mode over the engagement speed as soon as the change in speed per time unit is greater than the third limit value as provided for previously. As soon as the change in speed per time unit is less than a fourth limit value, the control device controls the supplied amount of fuel and the ignition time such that the internal combustion engine decelerates down to the idling speed. The fourth limit value characterizes the releasing of the throttle lever by the operator. Advantageously, both the acceleration and the deceleration take place automatically via the engagement speed, and it is therefore possible to ensure in a simple manner that the centrifugal clutch is not operated for too long in the range of the engagement speed, allowing avoidance of excessive heating of the centrifugal clutch.

In still another embodiment, the determined engagement speed is stored in the control device. The determined engagement speed is used in particular to control the internal combustion engine. Advantageously, the idling speed may also be set to depend on the engagement speed stored in the control device. On account of operating errors, for example, when the internal combustion engine is stopped with the chain brake engaged in a chainsaw, the centrifugal clutch can become worn. Usually, the engagement speed drops in the event of wear as a result of improper handling. In order to maintain a sufficient safety buffer between the idling speed and the engagement speed, when the engagement speed drops the idling speed may likewise be lowered. As a result, the safety buffer that exists between the idling speed and the engagement speed can be less than in known working apparatuses having a fixed engagement speed that is set only once.

In another embodiment, the determined engagement speed is used to check whether the centrifugal clutch is operational or faulty. To this end, it is advantageously checked whether the engagement speed is within specified limits for the engagement speed. As soon as the engagement speed is outside the limits, indicating that the clutch is faulty, it is provided that the control device controls the internal combustion engine such that the speed remains below the engagement speed, irrespective of an operation carried out by the operator. As a result, operation of the working apparatus with a damaged centrifugal clutch is prevented. It can be provided that, once it has been set and stored in the control device, an engagement speed that lies outside the given limits can be restored only by servicing, thereby ensuring that a damaged centrifugal clutch is replaced. Advantageously, the engagement speed is stored such that it can be read out from the control device via a diagnostic device that is connectable to the working apparatus. The stored engagement speed is changeable, in particular editable and restorable, for example by the workshop. It may be advantageous for the determined engagement speed to be displayed as the clutch state, for example visually via a display or an LED light, or acoustically, for example via loudspeakers. As a result, the operator can be notified early about wear to the centrifugal clutch, for example on account of improper operation of the working apparatus.

In another embodiment, a method for operating a hand-held working apparatus is provided, wherein the method comprises providing a control device in an internal combustion engine, monitoring the profile of the speed of the internal combustion engine using the control device, and determining an engagement speed of a clutch in the internal combustion engine from the profile of the speed of the internal combustion engine using the control device.

In still another embodiment, the method also includes determining a first speed and second speed from the profile of the speed of the internal combustion engine using the control device as stated previously, and storing a first speed and a second speed on the control device. Advantageously, the method may also include determining the engagement speed as the average of the value of the first speed and the second speed using the control device. In another advantageous aspect, the method may include controlling the internal combustion engine using the control device and one or more of the first speed, second speed, and engagement speed.

In yet another embodiment, the method may include storing a third speed on the control device, wherein the third speed characterizes the rise in the speed during acceleration from the idling mode, accelerating the internal combustion engine from an idling mode over the engagement speed when the change in speed over time of the internal combustion engine exceeds the third value by controlling the amount of fuel supplied to the internal combustion engine or the ignition time of an ignition device or both using the control device, and determining the engagement speed each time that the change in speed over time of the internal combustion engine exceeds a third speed using the control device.

In another embodiment, the method may also comprise determining a fourth speed, wherein the fourth speed characterizes the releasing of the throttle by the operator and decelerating the internal combustion engine down to the idling speed when the change in speed over time of the internal combustion engine falls below the fourth speed.

Further objects, features, and advantages of the present invention will become apparent from the detailed description of preferred embodiments of the invention which is set forth below, when considered together with the figures of drawing.

### BRIEF DESCRIPTION OF THE DRAWINGS

Several exemplary embodiments of the invention are explained below with reference to the drawings, in which:

FIG. 1 shows a side view of a cut-off grinder, which is one exemplary embodiment of a working apparatus,

FIG. 2 shows a schematic sectional illustration through the cut-off grinder from FIG. 1 along the line II-II in FIG. 1,

FIG. 3 shows a schematic illustration of the internal combustion engine of the cut-off grinder from FIG. 1,

FIG. 4 shows a side view of the centrifugal clutch of the cut-off grinder from FIG. 1,

FIG. 5 shows a diagram that indicates the speed profile during acceleration for the cut-off grinder from FIG. 1,

FIG. 6 shows a perspective illustration of a brushcutter, which is another exemplary embodiment of a working apparatus,

FIG. 7 shows a diagram that schematically indicates the speed profile during acceleration for the brushcutter from FIG. 6,

FIG. 8 shows a side view of a chainsaw, which is another exemplary embodiment of a working apparatus,

FIG. 9 shows a diagram that indicates the speed profile during acceleration for the chainsaw from FIG. 8,

FIG. 10 shows a diagram that shows one exemplary embodiment of a method of operating a hand-held working apparatus, and

FIG. 11 shows a diagram that indicates the speed profile for acceleration and subsequent deceleration for the cut-off grinder from FIG. 1.

### DETAILED DESCRIPTION OF PREFERRED EMBODIMENTS

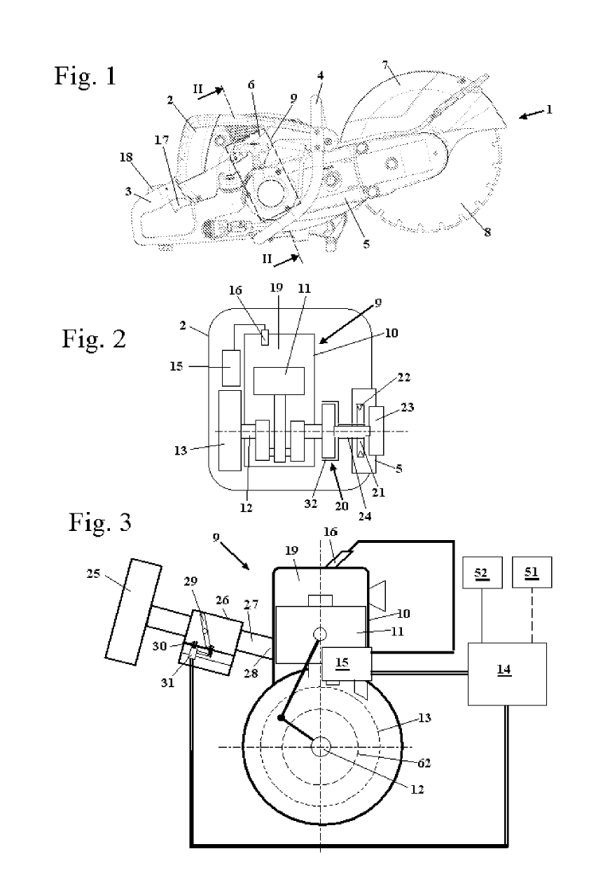

Turning now to the drawings, FIG. 1 shows a cut-off grinder 1 as an exemplary embodiment of a hand-held working apparatus. The cut-off grinder 1 has a housing 2 on which a rear handle 3 and a bale handle 4 are secured via anti-vibration elements (not shown). Arranged on the rear handle 3 are a throttle lever 17 and a throttle lever lock 18. Arranged in the housing 2 is an internal combustion engine 9, shown schematically in FIG. 1, which is in the form of a single-cylinder two-stroke engine. Out of the housing 2 there projects a starter handle 6, via which the starter device 23, shown in FIG. 2, for the internal combustion engine 9 is intended to be actuated. Arranged on the housing 2 is a cantilever arm 5, at the forwardly projecting end of which there is arranged a protective hood 7. The protective hood 7 engages over a cutting disk 8 mounted in a rotating manner on the cantilever arm 5. The cutting disk 8 is driven by the internal combustion engine 9 via a drive belt 22, shown in FIG. 2, which runs in the cantilever arm 5.

As FIG. 2 shows, the internal combustion engine 9 has a cylinder 10 in which a piston 11 is arranged in a reciprocating manner. The piston 11 bounds on one side a combustion chamber 19 and drives a crankshaft 12 in rotation. The cut-off grinder 1 has a fanwheel 13, which is connected to the crankshaft 12 so as to rotate therewith. Arranged on the fanwheel 13 are magnets (not shown), which induce the ignition voltage in an ignition device 15 arranged on the outer circumference of the fanwheel 13. The ignition device is connected to a spark plug 16 that projects into a combustion chamber 19 bounded on one side by the piston 11. The crankshaft 12 is furthermore connected to a centrifugal clutch 20 so as to rotate therewith. Secured to the clutch drum 32 of the centrifugal clutch 20 is an output shaft 24 which is connected to a belt pulley 21 so as to rotate therewith. The drive belt 22 is guided around the belt pulley 21. Arranged on that side of the belt pulley 21 that is remote from the centrifugal clutch 20 is the starter device 23, which acts on the crankshaft 12 of the internal combustion engine 9.

FIG. 3 shows the structure of the internal combustion engine 9 in detail. The internal combustion engine 9 has an intake duct 27 which opens into the cylinder 10 via an inlet 28. The inlet 28 is slot-controlled by the piston 11. The intake duct 27 is connected to an air filter 25, via which combustion air is sucked in. Provided for supplying fuel is a carburetor 26, in which a throttle valve 29 is mounted in a pivotable manner. In addition, a choke valve can also be arranged in the carburetor 26. In the region of the throttle valve 29, fuel openings 30 open into the intake duct 27. The amount of fuel supplied via the fuel openings 30 is controlled by a valve 31. The valve 31 is in particular an electromagnetic valve. The valve 31, which is in the form of a metering valve, is controlled by a control device 14. The control device 14 is also connected to the ignition device 15 and controls the ignition time. The control device 14 can be integrated into the ignition device 15. The control device 14 can be connected to a diagnostic device 51, in particular during servicing for the maintenance of the cut-off grinder 1. The connection can take place directly via the control device 14 or else via the connector of the spark plug 16 or via a generator 62 arranged on the crankshaft 12. A display 52 is furthermore connected to the control device 14. Instead of the display 52, a lamp, such as an LED, for example, or a loudspeaker can also be connected.

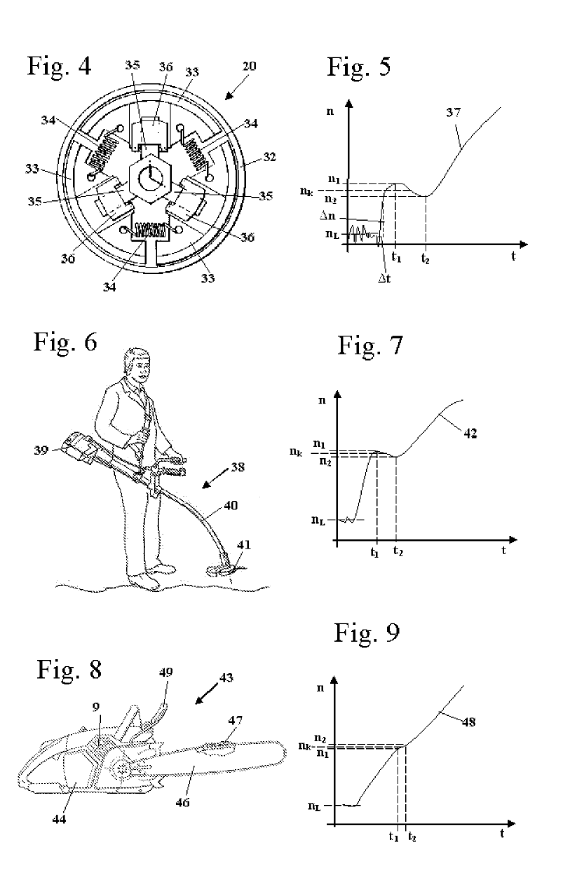

FIG. 4 shows the centrifugal clutch 20 in detail. Within the clutch drum 32, a total of three centrifugal weights 33 are arranged in a radially movable manner. The centrifugal weights 33 are guided in the radial direction on guides 35. A guide inclined with respect to the radial direction can also be provided. In the axial direction, the centrifugal weights 33 are secured on the guides 35 by holders 36. The centrifugal weights 33 are connected together via springs 34 which are in the form of helical tension springs and bias the centrifugal weights 33 radially inward. If the centrifugal force acting on the centrifugal weights 33 on account of the rotational movement of the crankshaft 12 is sufficiently great and overcomes the force applied by the springs 34, then the centrifugal weights 33 move radially outward and come into contact with the clutch drum 32. As a result, the output shaft 24 is entrained. During the engagement process, slip occurs between the centrifugal weights 33 and the clutch drum 32. As soon as the centrifugal weights 33 have been connected in a force-fitting manner to the clutch drum 32, the crankshaft 12 and the output shaft 24 rotate at the same speed.

FIG. 5 shows the speed profile after starting during the acceleration of the cut-off grinder 1. The speed profile can be determined from the voltage profile induced in the ignition device via the magnets of the fanwheel 13. However, a generator 62 shown in FIG. 3 can also be arranged on the crankshaft 12, with the profile of the speed n of the crankshaft 12 being determined from the signal of said generator 62. Other means for recording the speed profile can also be provided. Initially, the speed n fluctuates around the idling speed n_{L}. The fluctuations occurring here are comparatively large. As soon as the operator actuates the throttle lever 17, the speed n rises strongly to a first speed n₁. At the speed n₁, the centrifugal weights 33 start to come into contact with the clutch drum 32. As a result of the entrainment of the cutting disk 8, the crankshaft 12 is initially slowed, such that the speed n drops to a second speed n₂. At the speed n₂, the centrifugal weights 33 have come into contact in a force-fitting manner with the clutch drum 32. The speed n than rises strongly again. The speed profile is illustrated by the line 37. As FIG. 5 shows, the speed n₁ prevails at a time t₁ and the speed n₂ at a time t₂. Starting from the time t₁, the change in speed Δn per time unit Δt drops below a first limit value GW1 stored in the control device, and starting from the time t₂, the change in speed Δn per time unit Δt, i.e. the acceleration of the crankshaft 12, rises above a second limit value GW2. The engagement speed nₖ of the centrifugal clutch 20 can be determined from the profile of the speed n via the first of the speed n₂ and the second speed n₂. As the engagement speed nₖ, advantageously the average between the speeds n₂ and n₂ is in this case determined, specifically in particular as half the sum of the speeds n₂ and n₂.

In one embodiment, it is provided that the engagement speed nₖ is determined each time the internal combustion engine 9 is accelerated from the idling speed n_{L}. In order to differentiate between an acceleration process and the usual speed fluctuations in the idling mode, it is provided for the acceleration, i.e. the change in speed Δn with respect to a time unit Δt, to be evaluated and to be compared with a limit value GW3 stored in the control device 14. There is an acceleration wish on the part of the operator when the limit value GW3 is exceeded over a given time period. The speed n measured is in this case the speed of the crankshaft 12.

FIG. 6 shows, as a further example of a hand-held working apparatus, a brushcutter 38. The brushcutter 38 has a housing 39, in which an internal combustion engine 9 (not shown) is arranged. The structure of the internal combustion engine 9 can correspond to the structure shown in FIGS. 2 and 3. The brushcutter 38 has a guide tube 40 through which a driveshaft (not shown) is guided. Via the driveshaft, the internal combustion engine drives a string trimmer head 41 arranged at the bottom end of the guide tube 40.

FIG. 7 shows the speed profile during the acceleration of the internal combustion engine of the brushcutter 38 as a line 42. As FIG. 7 shows, the speed n initially fluctuates around an idling speed n_{L}. Subsequently, the speed rises very strongly to a first speed n₁ at a time t₁. Subsequently, the speed n drops until the time t₂ to a speed n₂ in order subsequently to rise again. At the time t₁, the centrifugal weights 33 start to come into contact with the clutch drum 32. At the time t₂, the centrifugal clutch 20 is fully engaged. As engagement speed nₖ, the geometric average between the speeds n₁ and n₂ is determined. As FIG. 7 shows, the difference between the speeds n₁ and n₂ is much smaller in a brushcutter 38 than in a cut-off grinder 1. However, in the brushcutter 38, too, the speed n₂ is less than the speed n₁.

FIG. 8 shows, as a further exemplary embodiment of a hand-held working apparatus, a chainsaw 43. The chainsaw 43 has a housing 44, in which an internal combustion engine 9 is arranged. Fixed to the housing 44 is a guide rail 46 on which a saw chain 47 is arranged in a circulating manner. The saw chain 47 is driven by the internal combustion engine 9. The chainsaw 43 has a chain brake, which can be actuated or released via a chain brake arm 49.

As is shown by the line 48 in FIG. 9, which shows the speed profile of the crankshaft 12 of the chainsaw 43 during acceleration, the speed n initially fluctuates around the idling speed n_{L}, in order then to rise to a speed n₁ at a time t₁. Subsequently, the speed rises only slightly to a speed n₂ until a time t₂. After the time t₂, the speed n rises much more strongly again. The engagement speed nₖ results as the average between the speeds n₁ and n₂. This is calculated by the control device 14. In a chainsaw 43, the second speed n₂ can be greater than the first speed n₁ since the mass of the tool in a chainsaw is less than for example in a cut-off grinder.

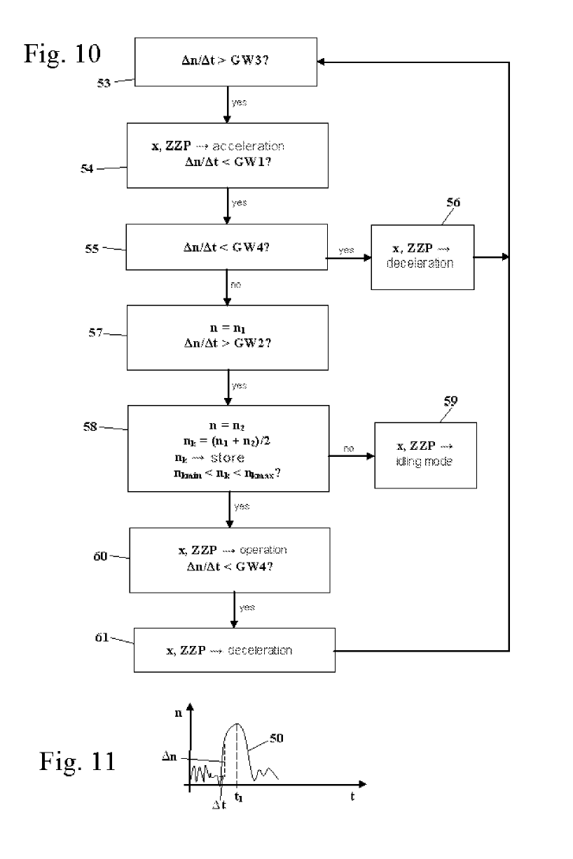

FIG. 10 shows one exemplary embodiment of a method of operating a hand-held working apparatus, for example the cut-off grinder 1, the brushcutter 38 or the chainsaw 43. In the idling mode, the acceleration, i.e. the change in speed Δn per time unit Δt, is monitored and compared continuously with a third limit value GW3. This takes place in method step 53. Even in the idling mode, accelerations which are greater than the third limit value GW3 can occur. However, in the idling mode, these accelerations occur only briefly, whereas during an acceleration process, the limit value GW3 is exceeded for a longer time period. If the change in speed Δn with respect to a time unit Δt is greater than the third limit value GW3 over a given time period, then the operator wants to accelerate, and so the control device 14 controls the internal combustion engine 9 such that the internal combustion engine 9 accelerates. To this end, the supplied amount of fuel x or the ignition time ZZP or both are set to appropriate values for the acceleration. This takes place in method step 54.

Rather than via the speed profile, an acceleration wish on the part of the operator can also be detected via the actuation of an operating element. For example, in order to accelerate, the operator can actuate an operating element for acceleration. There can also be provided an automatic starter device to be actuated by the operator. In order to start the internal combustion engine, the operator has to actuate the start button. After starting, an acceleration wish on the part of the operator is assumed automatically and the internal combustion engine automatically accelerates after starting.

During the acceleration process, the current value of the acceleration, i.e. the change in speed Δn with respect to a time unit Δt, is compared with a first limit value GW1. As soon as the change in speed Δn with respect to the time unit Δt is less than the first limit value GW1, then the time t₁ has been reached. It must then be checked whether the operator wants to accelerate further, and the reduced acceleration results from the engagement process of the centrifugal clutch 20, or whether the operator has released the throttle lever 17, and thus the internal combustion engine 9 is intended to drop back into the idling mode. To this end, in method step 55, the change in speed Δn per time unit Δt is compared with a fourth limit value GW4. If the acceleration is below the fourth limit value GW4, then, in method step 56, the supplied amount of fuel x or the ignition time ZZP or both are controlled in a manner corresponding to a deceleration. The resulting speed profile is indicated in FIG. 11 as the line 50.

If the acceleration does not drop below the fourth limit value GW4, then the current speed n corresponds to the first speed n₁. Subsequently, in method step 57, it is monitored whether the change in speed Δn with respect to the time unit Δt rises again and exceeds the second limit value GW2. As soon as the second limit value GW2 has been reached, the current speed corresponds to the second speed n₂. In method step 58, the engagement speed nₖ is calculated as the average between the speeds n₁ and n₂ and the engagement speed nₖ is stored in the control device 14. Subsequently, it is determined whether the engagement speed nₖ is greater than a lower limit nₖₘᵢₙ or less than an upper limit nₖₘₐₓ. If the engagement speed nₖ is furthermore these limits, in particular below the lower limit nₖₘᵢₙ, then the centrifugal clutch 20 is faulty. Therefore, in method step 59, the supplied amount of fuel x or the ignition time ZZP or both are controlled such that the internal combustion engine 20 is operated in the idling mode. As a result, acceleration to the engagement speed nₖ, even with the throttle lever 17 fully actuated, is no longer possible.

If the determined engagement speed nₖ is within the permitted limits nₖₘᵢₙ and nₖₘₐₓ, then in method step 60 the supplied amount of fuel x or the ignition time ZZP or both are controlled in accordance with the usual criteria for the operation of the internal combustion engine 9, in particular for full load. In operation, it is continuously monitored whether the change in speed Δn with respect to the time unit Δt drops below the fourth limit value GW4, i.e. the speed n drops strongly. In this case, the operator wants to decelerate the internal combustion engine 9. If this is the case, then in method step 61 the amount of fuel x or the ignition time ZZP or both are controlled such that the internal combustion engine 9 decelerates, i.e. the speed n drops quickly to the idling speed n_{L}.

On account of the fact that the amount of fuel x or the ignition time ZZP or both are controlled automatically by the control device 14 both during acceleration and during deceleration, very quick acceleration and quick deceleration can be achieved. As a result, it is also ensured that the speed n of the internal combustion engine dwells no longer than necessary between the first speed n₁ and the second speed n₂, and so undesired heating of the centrifugal clutch 20 can be avoided.

The determined engagement speed nₖ allows conclusions to be drawn about the state of wear of the centrifugal clutch 20. The clutch state can be displayed to the operator for example via the display 52 or an LED or the like provided instead of the display 52. An acoustic display, for example via a loudspeaker, is also possible. Wear of the centrifugal clutch 20 can result in the case of operating errors on the part of the operator, for example when, after starting, the operator does not actuate the chain brake arm 49 shown in FIG. 8 and thus does not disengage the chain brake, but accelerates with the chain brake engaged. The clutch drum 32 then cannot rotate together with the outwardly pushed centrifugal weights 33, and so a high degree of wear can result.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

1. A hand-held working apparatus comprising a control device, an internal combustion engine, a crankshaft, a tool, a centrifugal clutch, and a device for determining the speed of the internal combustion engine,
wherein the control device evaluates a profile of the speed of the internal combustion engine and determines an engagement speed of a centrifugal clutch from the profile of the speed of the internal combustion engine.

2. The hand-held working apparatus according to claim 1,
wherein the control device stores a first speed and a second speed,
wherein the first speed and the second speed are independent values of the change in speed per time unit,
wherein the control device independently determines the first speed and the second speed from the profile of the speed.

3. The hand-held working apparatus according to claim 2,
wherein the control device determines the engagement speed as the average of the value of the first speed and the second speed.

4. The hand-held working apparatus according to claim 1,
wherein the control device determines the engagement speed each time that the speed of the internal combustion engine rises more strongly from the idling mode over a given time period than a third limit value of the change in speed per time unit,
wherein the third limit value is stored in the control device.

5. The hand-held working apparatus according to claim 1,
wherein the internal combustion engine further comprises a device for supplying fuel and an ignition device,
wherein the control device controls the amount of fuel supplied to the internal combustion engine by the device for supplying fuel and the ignition time of the ignition device.

6. The hand-held working apparatus according to claim 5,
wherein the control device controls the supplied amount of fuel or the ignition time or both,
wherein the internal combustion engine accelerates from the idling mode over the engagement speed as soon as the change in speed per time unit is greater than a third limit value.

7. The hand-held working apparatus according to claim 5,
wherein the control device controls the supplied amount of fuel or the ignition time or both,
wherein the internal combustion engine decelerates down to the idling speed as soon as the change in speed per time unit is less than a fourth limit value.

8. The hand-held working apparatus according to claim 1,
wherein the engagement speed is stored in the control device.

9. The hand-held working apparatus according to claim 8,
wherein the engagement speed is used to control the internal combustion engine.

10. The hand-held working apparatus according to claim 9,
wherein the idling speed changes in correlation with the engagement speed stored in the control device.

11. The hand-held working apparatus according to claim 9,
wherein the control device determines whether the engagement speed is within specified limits and, as soon as the engagement speed is outside the limits, the control device controls the internal combustion engine such that the speed remains below the engagement speed.

12. The hand-held working apparatus according to claim 8,
wherein the engagement speed is stored such that it can be read out from the control device or changed or both by a diagnostic device that is connectable to the working apparatus.

13. The hand-held working apparatus according to claim 1,
wherein the determined engagement speed is displayed as the clutch state.

14. A method for operating a hand-held working apparatus, the method comprising:
providing a control device in an internal combustion engine,
monitoring the profile of the speed of the internal combustion engine using the control device,
determining an engagement speed of a clutch in the internal combustion engine from the profile of the speed of the internal combustion engine using the control device.

15. The method according to claim 14, wherein the method further comprises:
determining a first speed and second speed from the profile of the speed of the internal combustion engine using the control device, wherein the first speed and second speed are independent values of the change in speed per time unit, wherein the first speed characterizes the speed at which a clutch begins to engage, wherein the second speed characterizes the speed at which the clutch has fully engaged,
storing a first speed and a second speed on the control device.

16. The method according to claim 15, wherein the method further comprises:
determining the engagement speed as the average of the value of the first speed and the second speed using the control device.

17. The method according to claim 14, wherein the method further comprises:
storing a third speed on the control device, wherein the third speed characterizes the rise in the speed during acceleration from the idling mode,
accelerating the internal combustion engine from an idling mode over the engagement speed when the change in speed over time of the internal combustion engine exceeds the third value by controlling the amount of fuel supplied to the internal combustion engine or the ignition time of an ignition device or both using the control device,
determining the engagement speed each time that the change in speed over time of the internal combustion engine exceeds a third speed using the control device.

18. The method according to claim 14, wherein the method further comprises:
determining a fourth speed, wherein the fourth speed characterizes the releasing of the throttle by the operator,
decelerating the internal combustion engine down to the idling speed when the change in speed over time of the internal combustion engine falls below the fourth speed.

19. The method according to claim 15, wherein the method further comprises:
controlling the internal combustion engine using the control device and one or more of the first speed, second speed, and engagement speed.
